(19) United States
(12) Patent Application Publication
(10) Pub. No.: US 2024/0142860 A1
(43) Pub. Date: May 2, 2024

(54) IMAGING DEVICE

(71) Applicant: Panasonic Intellectual Property Management Co., Ltd., Osaka (JP)

(72) Inventor: Katsuhiro KITADE, Kyoto (JP)

(73) Assignee: Panasonic Intellectual Property Management Co., Ltd., Osaka (JP)

(21) Appl. No.: 18/383,927

(22) Filed: Oct. 26, 2023

(30) Foreign Application Priority Data
Oct. 31, 2022 (JP) 2022-174689

(51) Int. Cl. G03B 17/56; H04N 23/51; H04N 23/55; H04N 23/60

(52) U.S. Cl. CPC G03B 17/563; H04N 23/51; H04N 23/55; H04N 23/665; G03B 2217/002

(57) ABSTRACT

An imaging device includes a camera main body, an imaging sensor, a grip part, and an output part. A camera main body includes a housing, and an imaging sensor is disposed inside the housing. The imaging sensor converts light into an electric signal. A grip part is attachable and detachable to/from the housing. An output part outputs an imaged image based on the electric signal. In an attachment and detachment direction of the grip part, the imaging sensor is disposed in a central portion of the housing.

### CROSS REFERENCE TO RELATED APPLICATION

This application claims benefit of priority to Japanese Patent Application 2022-174689, filed Oct. 31, 2022, the entire content of which is incorporated herein by reference.

### BACKGROUND

### Technical Field

The present disclosure relates to an imaging device.

### Background Art

A stationary imaging device that is fixed on a tripod or the like to shoot has traditionally been present. For example, JP2018148545A describes an imaging device having a box-like shape (that is a what-is-called box camera).

### SUMMARY

For the above stationary imaging device, JP2018148545A does not take into consideration realization of two types of shooing style that are fixed shooting and hand-held shooting. Assuming that the stationary imaging device can realize these two types of shooting style, the stationary imaging device can provide a user with various shooting styles for the user. The stationary imaging device is however designed to be used for fixed shooting as a precondition and, especially, when the box camera is directly griped and hand-held shooting is thereby executed, the griping itself tends to be unstable. Furthermore, for example, the user's fingers touch the lens, and the focus and the aperture value may thereby be varied, or the fingers may cover the lens to be shot, and the hand-held shooting is therefore difficult. Devices such as a large-scale optional item are therefore necessary in the case where hand-held shooting is tried to be executed using the stationary imaging device.

Therefore, the present disclosure provide an imaging device capable of easily realizing two types of shooting style.

An imaging device in one aspect of the present disclosure includes a camera main body that includes a housing, an imaging sensor that is disposed inside the housing and that converts light into an electric signal, a grip part that is attachable and detachable to/from the housing, and an output part that outputs an imaged image based on the electric signal. In an attachment and detachment direction of the grip part, the imaging sensor is disposed in the central portion of the housing.

According to an imaging device of the present disclosure, an imaging device capable of easily realizing two types of shooting style is provided.

### BRIEF DESCRIPTION OF DRAWINGS

FIG. 1 is a front perspective diagram of a camera in an embodiment of the present disclosure;

FIG. 2 is a rear perspective diagram of the camera in the embodiment of the present disclosure;

FIG. 3 is a rear perspective diagram of the camera in the embodiment of the present disclosure;

FIG. 4 is a front perspective diagram of a duct part in a housing of a camera main body in the embodiment of the present disclosure;

FIG. 5 is a front elevation diagram of the camera main body in the embodiment of the present disclosure;

FIG. 6 is a front perspective diagram of a grip part in the embodiment of the present disclosure;

FIG. 7 is a front elevation diagram of the camera in the state where the camera has the grip part attached thereto;

FIG. 8 is a rear perspective diagram of the camera in the state where the camera has the grip part attached thereto;

FIG. 9 is a front perspective diagram of the camera in the state where the camera has an accessory part attached thereto; and

FIG. 10 is a front perspective diagram of the camera in the state where the camera has another accessory part attached thereto.

### DETAILED DESCRIPTION

A box-type single-lens camera as a specific embodiment of an electronic device and an imaging device of the present disclosure will be described below with reference to the accompanying drawings. The electronic device and the imaging device of the present disclosure are not limited to the configuration of the camera described in the following embodiment and encompass the configurations of an electronic device and an imaging device that are based on a technique equivalent to the technical idea having the technical features described in the following embodiment.

The shapes, the configurations, and the like presented in the following embodiment each indicate one example, and do not limit the invention to the content of the present disclosure. Of the constituent elements in the following embodiment, the constituent elements not described in the independent claim that describes the most generic concept will be described as optional constituent elements. In the embodiments, the same elements will be denoted by the same reference numerals and may not be described again.

(Embodiment)

[1-1. Configuration]

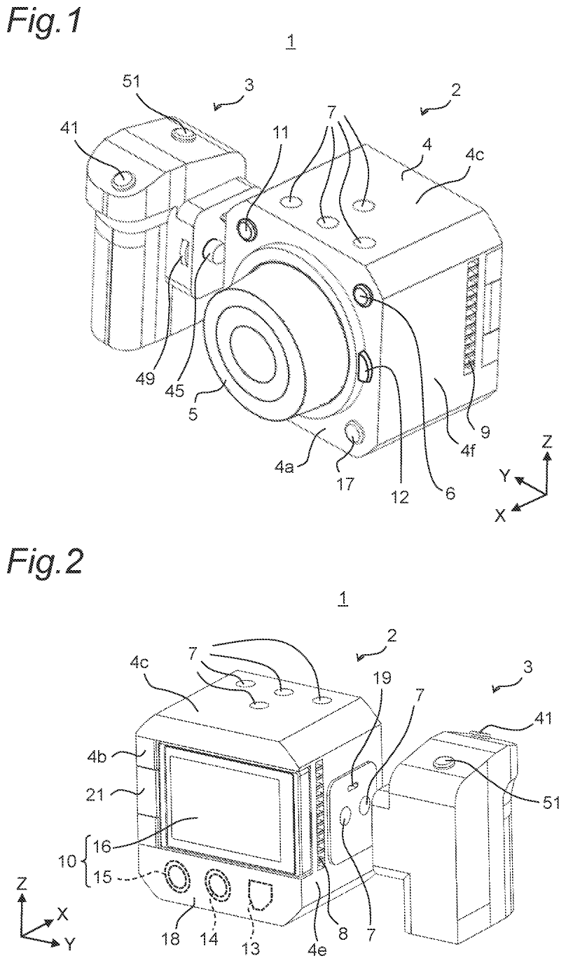

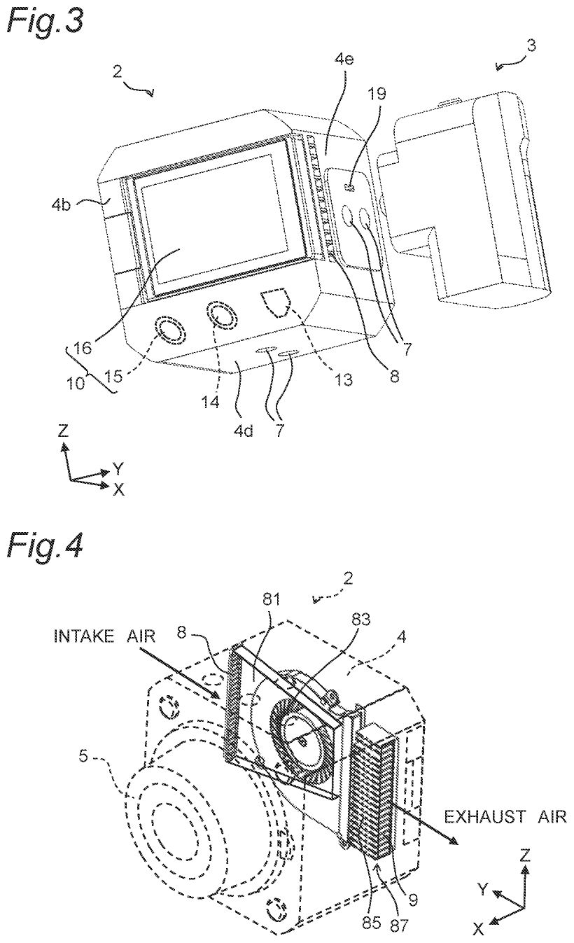

A camera 1 that is an imaging device of a first embodiment according to the present disclosure will be described below with reference to the drawings. FIGS. 1 to 3 are perspective diagrams of the camera 1 of the first embodiment, each taken when the camera 1 is seen from one of three directions. FIG. 1 is the perspective diagram of the camera 1 in the state where a grip part 3 is detached from a camera main body 2, taken when the camera 1 is seen from obliquely above on the right front side thereof. FIG. 2 is the perspective diagram of the camera 1 in the state where the grip part 3 is detached from the camera main body 2, taken when the camera 1 is seen from obliquely above on the left rear side thereof. FIG. 3 is the perspective diagram of the camera 1 in the state where the grip part 3 is detached from the camera main body 2, taken when the camera 1 is seen from obliquely underneath on the left rear side thereof.

In FIGS. 1 to 3, for convenience, an X-axis, a Y-axis, and a Z-axis each intersecting each other at a right angle are depicted, and the front-back direction of the camera 1 in the first embodiment (an X-axis direction), the right-left direction thereof (a Y-axis direction), and the up-down direction thereof (a Z-axis direction) will be described using the X-axis, the Y-axis, and the Z-direction. In the description of the camera 1 of the first embodiment, the side on which an interchangeable lens 5 is attached to the camera main body 2 (an object side) is defined as the front side, and the right side and the left side are defined as those that are taken when the camera 1 is seen from the front side thereof. In the following description, in the case where the X-direction, the Y-direction, and the Z-direction are each simply presented, these directions are the axis directions thereof, and each thereof includes the two directions that are opposite to each other. In the case where a direction is identified as a positive direction of the X-axis, the direction is the one direction from the rear side to the front side. In the case where a direction is identified as a positive direction of the Y-axis, the direction is the one direction from the right side to the left side. In the case where a direction is identified as a positive direction of the Z-axis, the direction is one direction from the lower side to the upper side.

The camera 1 of the embodiment includes the camera main body 2 that includes a housing 4, and the grip part 3 that is attachable and detachable to/from the camera main body 2. The camera main body 2 is a box-shaped single-lens camera that is usable by itself using external power feeding or the like even without the grip part 3. With the camera main body 2, plural camera main bodies each having the configuration same as that of the camera main body 2 can be synchronously used, and the camera main body 2 can process at high resolution various types of video image such as a panoramic video image and a three-dimensional video image. The camera main body 2 of the first embodiment is small-sized and lightweight, and is remote-controllable.

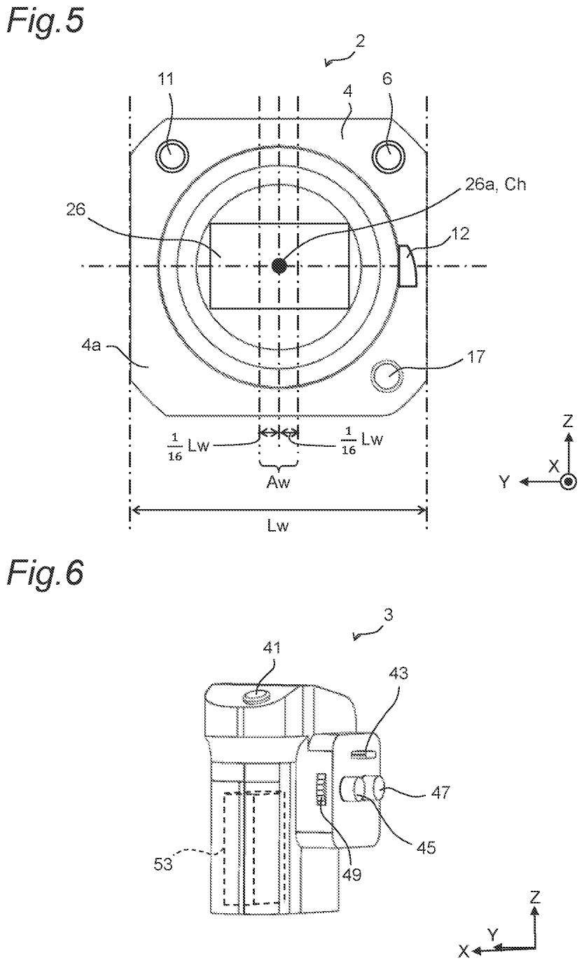

The camera main body 2 of the embodiment is a camera of the type called “box camera”. The box camera is different from the traditional single-lens camera to have an imaging sensor 26 located in the central portion of the housing 4 in the right-left direction (see FIG. 5). Plural holes for installing the camera main body 2 are located on the outer side face of the camera main body 2.

As depicted in FIGS. 1 to 3, the housing 4 of the camera main body 2 to which the interchangeable lens 5 is attached has a box-like shape and has, for example, a substantially hexahedral shape. In the embodiment, the housing 4 has a substantially cubic box-like shape. Because the camera main body 2 has the box-like shape as above, the camera main body 2 is usable in a small space in the case where the camera main body 2 is used by itself.

The housing 4 includes a first face 4a that is a front face, a second face 4b that is a back face facing the first face 4a, a third face 4c that is a top face, a fourth face 4d that is a bottom face facing the third face 4c, a fifth face 4e that is a left face, and a sixth face 4f that is a right face facing the fifth face 4e. The first face 4a has the interchangeable lens 5 attached thereto. The housing 4 is formed by a metal that has high heat conductivity and that is lightweight, such as, for example, an aluminum alloy.

The interchangeable lens 5 is detachably attached to a central portion on the side of the front face having a substantially square shape of the housing 4. A bayonet method of fixing the interchangeable lens 5 by rotation thereof is used as the method of attaching the interchangeable lens 5 to the housing 4. In the case where the interchangeable lens 5 is detached from the housing 4, the interchangeable lens 5 can be detached by pressing a lens detachment button 12 and rotating the interchangeable lens 5. The attachment method is however not limited to this attachment method and another attachment method generally used may be applied thereto.

A power source button 11, a function button 6, the lens detachment button 12, and a shutter button 17 are located on the front side of the housing 4 to surround the interchangeable lens 5. The function button 6 has a function of executing settings, adjustments, and the like for various types of functions of the camera main body 2 while the details of the function will not be described.

For example, screw holes 7 are formed on each of the side faces of the housing 4, each as a fixing part to fix the camera main body 2. The screw holes 7 of the embodiment are located at plural points in each of the two faces of the upper and the lower faces (the third face 4c and the fourth face 4d) and the left side face (the fifth face 4e) of the housing 4. The housing 4 therefore can have a frame for fixation attached thereto on any side face thereof that are the upper, the lower, and the left side faces, and the degree of freedom of attachment thereof to a tripod, an arm, or the like for fixation can be increased. The plural screw holes 7 located in the fourth face 4d of the housing 4 are holes with which the housing 4 can be fixed on a tripod using screws, and are one example of plural holes for installing the camera main body 2.

A user can shoot an object in a fixed shooting style by fixing the camera main body 2 on, for example, a tripod. Executing the fixed shooting enables, for example, shooting by remote control in the state where no person is present around the camera main body 2, and shooting synchronized with other cameras in the state where no person is present therearound.

The plural screw holes 7 located on each of the side faces of the housing 4 are also usable as holes to fix an accessory part to be attached to the camera main body 2 in addition to being used as the holes to install the camera main body 2. Examples of the accessary part include, for example, a microphone, an external monitor, and an adaptor that holds an external storage medium or the like.

As depicted in FIG. 1, the camera main body 2 of the embodiment has an air outlet 9 that is a longitudinally elongated opening to be long in the up-down direction, formed in the sixth face 4f on the right side of the housing 4. As depicted in FIG. 2, the camera main body 2 thereof has an air inlet 8 that is a longitudinally elongated opening to be long in the up-down direction, formed in the fifth face 4e on the left side of the housing 4. As depicted in FIG. 4, a duct part 81 as a cooling flow path is located inside the housing 4, and a cooling fan 83 is located in the duct part 81. The cooling fan 83 causes the external air to be suctioned from the air inlet 8 and causes the suctioned external air to pass through the duct part 81 to be discharged from the air outlet 9. A heat sink 87 including fins is attached inside the duct part 81, and the inside of the housing 4 is efficiently cooled using the heat sink 87.

The outer appearance shape of the housing 4 in the embodiment is the substantially cubic box-like shape that is constituted by a hexahedron while the border portion between any two faces of the main six faces constituting the hexahedron includes an inclined face that is inclined against each of the two faces.

Since the screw holes 7 are located in the third face 4c on the upper side of the camera main body 2 of the embodiment, an accessory part can be attached. Using the screw holes 7, the camera main body 2 may be fixed on another holding tool such as, for example, a frame, or may be fixed on an arm suspended from the ceiling. In the embodiment, three of the screw holes 7 are located in a row at regular intervals in the Y-direction (the right-left direction) and one of the screw holes 7 is further located in the central portion.

The screw holes 7 are located in the fourth face 4d on the lower side of the camera main body 2 of the embodiment, and the camera main body 2 can be fixed on a tripod, a cymbal, or the like. The screw holes 7 located in the fourth face 4d are mainly used as those for installation of the camera main body 2 while an accessary part can be attached therewith.

The screw holes 7 to be the fixation means for the camera main body 2 in the embodiment will be described with reference to an example where these screw holes 7 are located in the third face 4c, the fourth face 4d, and the fifth face 4e while the present disclosure is not limited to the above configuration and, as to the housing having the substantially hexahedral shape of the housing 4, a member to fix the camera 1 on another member only has to be located on each of the outer side faces.

the camera main body 2 of the embodiment has no battery attachment part to attach a battery, located in the housing 4. The disposition space for the duct part 81 and the cooling fan 83 can thereby be secured, and the cooling efficiency of the camera main body 2 can therefore be improved. The camera main body 2 has no battery attachment part located in the inside and on the outer side faces thereof, and the camera main body 2 can therefore be more downsized.

The camera main body 2 is located inside the housing 4, and includes the imaging sensor 26 that converts light into an electric signal (see FIG. 5), and an output part 10 that outputs an imaged image based on the electric signal (see FIGS. 2 and 3). The output part 10 includes a displaying part 16 that displays thereon an image, and a video image output terminal 15 as a connection part that connects to an external displaying part. The displaying part 16, or an external displaying part that is connected to the video image output terminal 15 enables the user to view the image imaged by the camera main body 2. The output part 10 may be configured to include at least one of the displaying part 16 and the video image output terminal 15.

A control terminal 13, a power source input terminal 14, and the video image output terminal 15 to execute transmission and reception of various types of signal to/from external devices are located in a lower portion of the second face 4b, and a resin terminal cover 18 is detachably located to cover these terminals. The power source input terminal 14, the control terminal 13, and the video image output terminal 15 are exposed by detaching the terminal cover 18. These connection terminals are covered by the terminal cover 18 when these connection terminals are not used, and the various types of connection terminals are configured to be in a drip-proof state when the terminal cover 18 is attached. A drip-proof effect is therefore secured.

the control terminal 13 is, for example, a female LAN terminal, and can be connected to an external controller through a LAN cable and the imaging by the camera main body 2 can be controlled by the external controller. The power source may be supplied through a LAN cable. In addition, transmission and reception of a time code, a genlock, USB, HDMI (a registered trademark), Eathernet, audio input and output signals may be executed therethrough.

Electric power can be externally supplied to the camera main body 2 by connecting a power source input cable to the power source input terminal 14.

A still image or a moving image imaged by the camera main body 2 is output to an external monitor or an external controller using, for example, an SDI signal, by connecting a signal cable to the video image output terminal 15.

The control terminal 13, the power source input terminal 14, and the video image output terminal 15 are located each directed obliquely downward and, when a cable is connected to any of these terminals, the cable therefore droops obliquely downward and does not consequently obstruct any operation for the displaying part 16.

The displaying part 16 supported by a rotation mechanism 21 of, for example, a free angle type is located in the central portion of the second face 4b. The displaying part 16 displays thereon a video image imaged by the camera main body 2 and an operation menu for the camera main body 2. The displaying part 16 is also acts as a touch panel and also has a function as an operating part that instructs an imaging operation to the camera main body 2. The displaying part 16 is, for example, a liquid crystal touch panel display.

As depicted in FIGS. 1 and 2, the housing 4 includes the air inlet 8 and the air outlet 9 that are located on the side of the displaying part 16 in the optical axis direction of the interchangeable lens 5, and the members to be the heat sources that are thermally connected to the duct part 81 connected to the air inlet 8 and the air outlet 9 such as, for example, a processor for image processing and the displaying part 16 can efficiently be cooled.

As depicted in FIG. 2, a first connector 19 for transmission and reception of control signals with the grip part 3 and to receive electric power feeding is located in the fifth face 4e on the left side of the housing 4. The first connector 19 is, for example, a female USB terminal. Two of the screw holds 7 are located along the optical axis direction in the fifth face 4e. The grip part 3 can be attached using the screw holes 7 in the fifth face 4e while another accessory part can also be attached.

The camera main body 2 depicted in FIG. 5 is in the state where the interchangeable lens 5 is detached therefrom. The imaging sensor 26 that converts the light entering the interchangeable lens 5 into an electric signal is located inside the housing 4 of the camera main body 2. The imaging sensor 26 images an object image formed through an optical system of the attached interchangeable lens 5, and forms image data.

The imaging sensor 26 includes, for example, a CCD image sensor, a CMOS image sensor, or an NMOS image sensor. Predetermined image processing is applied by an image processing circuit to the image data formed by the imaging sensor 26. The image data to which the predetermined image processing is applied is stored in a memory by a control circuit and is output based on an instruction from an external device. A circuit substrate holding the electric circuits such as the image processing circuit, the control circuit, and a power source circuit is held inside the housing 4.

As to the imaging sensor 26, the imaging sensor 26 is located in the central portion of the housing 4 in the attachment and detachment direction of the grip part 3, that is, the right-left direction (the Y-direction). As above, the box-shaped camera main body 2 includes the imaging sensor 26 that is located in the central portion of the housing 4 in the right-left direction. The central portion of the housing 4 in the right-left direction is a portion in a range Aw of the distance of 1/16Lw that is a 1/16-fold length of a length Lw in the right-left direction of the housing 4 in each of the rightward and the leftward directions from a center Ch in the right-left direction of the housing 4. In the embodiment, a center 26a in the right-left direction of the imaging sensor 26 coincides with the center Ch in the right-left direction of the housing 4. The length Lw in the right-left direction of the housing 4 of the camera main body 2 is equal to or shorter than a two-fold length of the diameter of the interchangeable lens 5. As above, the rate of the area occupied by the interchangeable lens 5 in the first face 4a of the housing 4 is large, and it is therefore difficult for the user to hook the first face 4a of the housing 4 with the user's fingers and any hand-held shooting consequently is difficult using the camera main body 2 alone. The imaging sensor 26 may be located in the central portion of the housing 4 in the up-down direction (the Z-direction).

The grip part 3 will be described with reference to FIG. 6. FIG. 6 is a perspective diagram of the grip part 3 taken when the grip part 3 is seen from the right front. The grip part 3 includes a shutter button 41, a second connector 43, a screw 45, a protrusion 47, a dial 49, a function button 51 (FIG. 8), and a battery 53. The visible outline in a transverse section of the grip part 3 has a U-like shape. and the grip part 3 has a shape for the user to easily grip.

The second connector 43 of the grip part 3 is a member that transmits an operational signal from the grip part 3 to the camera main body 2, and can transmit operational signals of the shutter button 41 and the function button 51 of the grip part 3 to the camera main body 2 by being connected to the first connector 19 of the camera main body 2. The function button 51 may have the same operational function as that of the function button 6 or may have another operational function. The battery 53 capable of being attached and detached is held inside the grip part 3, and electric power can be supplied from the battery 53 to the camera main body 2 through the second connector 43 of the grip part 3 and the first connector 19 of the camera main body 2. The second connector 43 is, for example, a male USB terminal. The method of feeding the electric power from the battery 53 to the camera main body 2 may be feeding the electric power by radio instead of feeding the electric power through the second connector 43 and the first connector 19.

The male screw 45 of the grip part 3 is inserted into the crew hole 7 on the front side of the fifth face 4e of the camera main body 2. The screw 45 can be rotated by rotating the dial 49, and the screw 45 of the grip part 3 and the screw hole 7 on the front side of the fifth face 4e can be coupled or decoupled to/from each other by rotating the dial 49 by the user.

The protrusion 47 located in parallel to and behind the screw 45 is inserted into the screw hole 7 on the back side of the fifth face 4e of the camera main body 2 to prevents any rotation of the grip part 3.

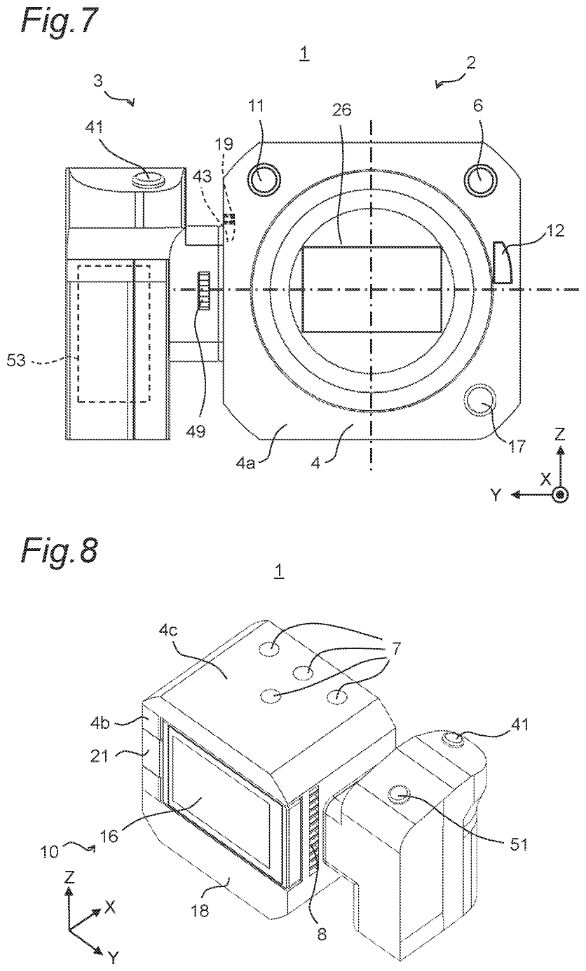

The description will be made with reference to FIGS. 7 and 8. FIG. 7 is a front elevation diagram of the camera 1 in the state where the camera main body 2 has the grip part 3 attached thereto. FIG. 8 is a perspective diagram of the camera 1 in the state where the camera main body 2 has the grip part 3 attached thereto.

The user can shoot by gripping the grip part 3 without directly holding the camera main body 2 by the user's hand, by attaching the grip part 3 to the camera main body 2, and prevention is therefore enabled against the fact that the focus and the aperture value of the interchangeable lens 5 attached to the camera main body 2 are varied and the fact that the fingers cover the interchangeable lens 5 to be shot. The user can easily maintain the horizontalness of the shot image by griping the grip part 3.

The electric power is supplied from the battery 53 attached inside the grip part 3 to the camera main body 2 through the second connector 43 and the first connector 19. The electric power does not therefore need to be received through the power source input terminal 14 and the power source cable connected to the power source input terminal 14 can therefore be detached, and the camera main body 2 can move regardless of the length of the power source cable to therefore be able to realize comfortable hand-held shooting. As above, the hand-held shooting style can easily be realized only by attaching the grip part 3 incorporating therein the battery 53 to the camera main body 2.

As depicted in FIGS. 8 and 1, the air inlet 8 is located on the side to which the grip part 3 is attached, of the housing 4 of the camera main body 2. The air outlet 9 is located on the side opposite to the side to which the grip part 3 is attached, of the housing 4. The air at a high temperature discharged from the air outlet 9 does not flow to the grip part 3, and the user's hand gripping the grip part 3 does not feel the flow of the air flowing into the air inlet 8, and the user can therefore be prevented from becoming uncomfortable.

In the case where the hand-held shooting style is changed to the fixed shooting style, the camera main body 2 can be used as a box camera for fixed shooting only by fixing the camera main body 2 on a tripod or the like, detaching the grip part 3 from the camera main body 2, and connecting the power source cable to the power source input terminal 14.

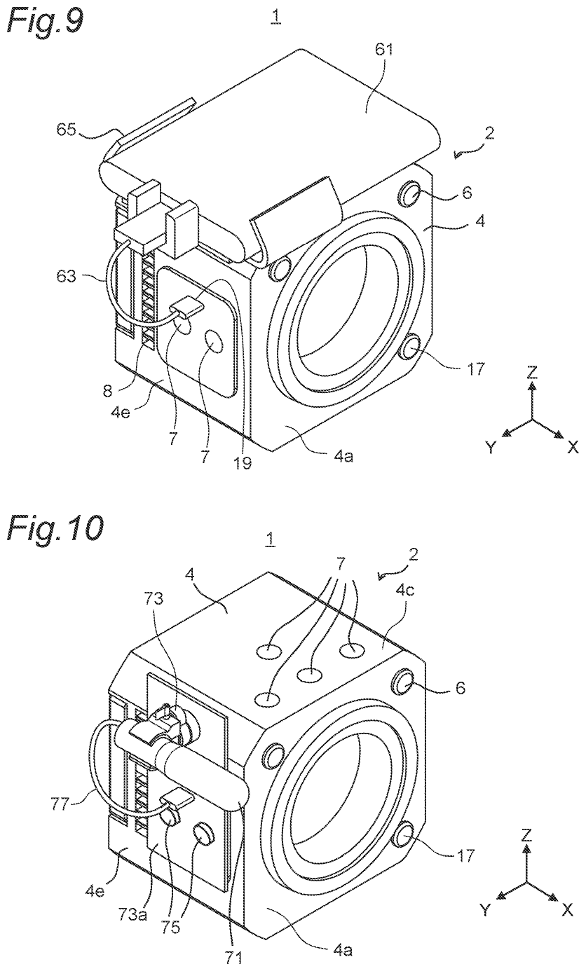

As depicted in FIGS. 9 and 10, another accessory part may be attached to the camera main body 2 instead of attaching the grip part 3 thereto. FIG. 9 depicts an example where, for example, an SSD (Solid State Drive) 61 is connected to the camera main body 2 as an external storage medium.

The SSD 61 is connected to the first connector 19 of the camera main body 2 by a USB cable 63. The image data formed by the imaging sensor 26 can thereby be stored in the SSD 61. The SSD 61 may also be fixed through an attachment holder 65 that is fixed in the screw hole 7 located in the third face 4c of the camera main body 2. A mobile battery may be connected to the camera main body 2 instead of the SSD 61.

FIG. 10 depicts an example where a microphone 71 is connected to the camera main body 2. The microphone 71 is connected to the first connector 19 of the camera main body 2 by a USB cable 77. Audio data formed by the microphone 71 can thereby be transmitted to the camera main body 2, and can be synthesized with the image data formed by the imaging sensor 26. The microphone 71 is detachably supported by, for example, an attachment holder 73, and a plate 73a of a bottom portion of the attachment holder 73 is fixed by a screw 75 in the screw hole 7 located in the fifth face 4e of the camera main body 2.

As above, the screw hole 7 located in the fifth face 4e of the camera main body 2 is not a hole dedicated to the attachment of the grip part 3 but is a general-purpose screw hole to which another accessory part can be attached. Similarly, the screw holes 7 located in the third face 4c and the fourth face 4d of the camera main body 2 are also general-purpose screw holes, and are therefore not only used for installation onto a tripod, an arm, or the like but also capable of attaching an accessory part thereto. The layout of the accessory part to be attached to the camera main body 2 can therefore be freely varied between, for example, fixed shooting by the camera main body 2 having the fourth face 4d of the housing 4 fixed to a tripod, and hand-held shooting by the camera main body 2 having the grip part 3 attached to the fifth face 4e of the housing 4, and the shooting can therefore be executed with any accessory part suitable for each of the shooting styles attached.

### 1-2. Effects, Etc.

As above, the camera 1 of this embodiment includes the camera main body 2 that includes the housing 4, the imaging sensor 26 that is located inside the housing 4 and that converts light into an electric signal, the grip part 3 capable of being attached and detached to/from the housing 4, and the output part 10 that outputs the imaged image based on the electric signal. The imaging sensor 26 is located in the central portion of the housing 4 in the attachment and detachment direction of the grip part 3.

According to the above camera 1, for the camera main body 2 having the imaging sensor 26 located in the central portion of the housing 4, the grip part 3 can be attached or detached to/from the housing 4 of the camera main body 2. The camera main body 2 can therefore be used as an imaging device in the state where the camera main body 2 alone is fixed on a supporting part, and shooting can also be executed carrying the camera main body 2 with the grip part 3 attached to the camera main body 2. The user can support the camera main body 2 by gripping the grip part 3 without directly holding the camera main body 2 with the user's hand only by attaching the grip part 3 to the camera main body 2, and the setting of the camera main body 2 can therefore be prevented from being varied by the user's fingers and the horizontalness of the camera main body 2 can easily be maintained. The hand-held shooting can therefore be easily executed. As above, the camera main body 2 is the box camera type while the options of the shooting method of the camera main body 2 can be increased to the two shooting styles that are the fixed shooting style and the hand-held shooting style.

In the camera 1 of this embodiment, the camera main body 2 includes the first connector 19 that transmits and receives the control signals, and the grip part 3 includes the second connector 43 that transmits and receives the control signals, and the battery 53 that is held inside the grip part 3. The electric power is sent from the battery 53 to the camera main body 2 by connecting the second connector 43 of the grip part 3 to the first connector 19 of the camera main body 2.

According to the above camera 1, the electric power is supplied from the battery 53 held inside the grip part 3 to the camera main body 2 through the second connector 43 and the first connector 19. The power source cable connected to the power source input terminal 14 can thereby be detached and the user can therefore freely move around and comfortable hand-held shooting can be realized.

### Other Embodiments

As above, the embodiment has been described as exemplification of the technique disclosed in the present application. The technique in the present disclosure is however not limited to the first embodiment, and is applicable to embodiments to which changes, substitutions, additions, omissions, and the like are made as necessary. The constituent elements described in the embodiment can also be combined with each other to create a new embodiment. Other embodiments will therefore be exemplified below.

The interchangeable lens 5 that is interchangeable is attached to the camera main body 2 in the above embodiment while the lens is not limited to the above. A fixed lens may be attached to the camera main body 2.

The screw holes 7 are located in the housing 4 of the camera main body 2 to attach various types of accessory in the above embodiment while the attachment means is not limited to the above. An accessory shoe to attach each of the various types of accessory may further be located in addition to the screw holes 7.

The output part 10 of the camera main body 2 includes both of the video image output terminal 15 and the displaying part 16 in the above embodiment while the output part 10 is not limited to the above. The output part 10 of the camera main body 2 may only include at least either one of the video image output terminal 15 and the displaying part 16. In the case where the output part 10 of the camera main body 2 does not include the displaying part 16, even in the state where the grip part 3 is attached to the camera main body 2, the user can easily execute the hand-held shooting checking the shot image by, for example, attaching an external monitor to the third face 4c of the housing 4 of the camera main body 2 and connecting the external monitor and the video image output terminal 15 to each other. In the case where the external monitor includes an SD card slot in a side face thereof and has a battery attachment part to which a battery can be attached, located on the side opposite to that of the monitor, the shot image by the camera main body 2 can be recorded in the SD card and power source supply to the external monitor can be executed from the battery that is attached to the external monitor, and the shooting can comfortably be executed for a long time even in the hand-held shooting style.

The grip part 3 is attached to the fifth face 4e on the left side of the camera main body 2 in the above embodiment while the attachment position is not limited to the above. The layouts of the constituent elements located on the fifth face 4e and the sixth face 4f on the right side of the camera main body 2 may be interchanged to each other to attach the grip part 3 to the sixth face 41.

As above, the embodiments have been described as exemplification of the technique in the present disclosure. The accompanying drawings and the detailed description have therefore been provided. The constituent elements depicted and described in the accompanying drawings and the detailed description may therefore include not only the constituent elements essential for solving the problem but also the constituent elements not essential for solving the problem but to exemplify the above technique. Readily recognizing those constituent elements that are not essential as essential constituent elements based on the fact that those constituent elements that are not essential are depicted and described in the accompanying drawings and the detailed description should therefore be avoided.

Since the above embodiment is for the purpose of exemplifying the technique of the present disclosure, various changes, permutations, additions, omissions, etc. can be made within the scope of claims or the scope of equivalents thereof.

What is claimed is:

1. An imaging device comprising:
a camera main body that comprises a housing;
an imaging sensor that is disposed inside the housing, the imaging sensor converting light into an electric signal;
a grip part that is attachable and detachable to/from the housing; and
an output part that outputs an imaged image based on the electric signal, wherein
in an attachment and detachment direction of the grip part, the imaging sensor is disposed in a central portion of the housing.

2. The imaging device according to claim 1, wherein
holes for installing the camera main body are disposed in at least one face of outer side faces of the housing.

3. The imaging device according to claim 2, wherein
a plurality of holes for attaching an accessory are disposed in an outer side face that is different from the outer side face having the hole for installing the camera main body, and wherein
the grip part is attachable and detachable to/from the holes for attaching the accessory part.

4. The imaging device according to claim 1, wherein
a shape of the housing is a box-like shape.

5. The imaging device according to claim 1, wherein
the output part comprises at least one of a displaying part that displays the image and a connection part that connects to an external displaying part.

6. The imaging device according to claim 1, wherein
the camera main body comprises
a first connector that transmits and receives a signal, wherein
the grip part comprises:
a second connector that transmits and receives a signal; and
a battery that is held inside the grip part, and wherein
the second connector of the grip part is connected to the first connector of the camera main body and electric power is thereby sent from the battery to the camera main body.

7. The imaging device according to claim 1, wherein
the camera main body comprises
a terminal for electric power to be externally supplied therethrough, and wherein
the camera main body does not comprise any battery attachment part to attach a battery thereto, in the housing and on the outer side faces of the housing.

8. The imaging device according to claim 1, wherein
the housing further comprises
a duct part for cooling, in an inside of the housing, and wherein
an air inlet of the duct part is disposed on a side for attaching the grip part, of the housing.

9. The imaging device according to claim 6, wherein
the grip part comprises
an operational button, and wherein
an operational signal of the operational button is sent to the camera main body by connecting the second connector of the grip part to the first connector of the camera main body.

10. The imaging device according to claim 2, wherein
the grip part comprises:
a screw;
a protrusion; and
a dial that rotates the screw, wherein
the screw and the protrusion of the grip part are each inserted into the hole of the housing of the camera main body, and wherein
when the dial is rotated, the screw is rotated to be fixed in the hole for attaching an accessary, of the housing of the camera main body.

11. The imaging device according to claim 3, wherein
the plurality of holes for installing the camera main body are disposed in a bottom face of the housing, and wherein
the plurality of holes for attaching an accessory are disposed in at least either one of a left face and a right face of the housing.
